(19) United States
(12) Patent Application Publication
(10) Pub. No.: US 2026/0075032 A1
(43) Pub. Date: Mar. 12, 2026

(54) SERIAL GROUP ID ADDRESS FOR AUTOMOTIVE ACTIVE/TUNABLE ANTENNAS

(71) Applicant: GM GLOBAL TECHNOLOGY OPERATIONS LLC, Detroit, MI (US)

(72) Inventors: Uriel Z. Odes, Givaat Shmuel (IL); Yossi Diller, Petah Tikva (IL)

(73) Assignee: GM GLOBAL TECHNOLOGY OPERATIONS LLC, Detroit, MI (US)

(21) Appl. No.: 18/828,437

(22) Filed: Sep. 9, 2024

(51) Int. Cl. H04L 61/5038; H01Q 1/32; H04B 1/00

(52) U.S. Cl. CPC H04L 61/5038; H01Q 1/32; H04B 1/0064

(57) ABSTRACT

A system, or systems, of using serial group ID address for automotive active/tunable antennas. The systems may include at least one antenna and one or more tuners. The systems may further include one or more identical antennas and each antenna includes at least two tuners and/or each antenna includes three or more tuners. A method, or methods, providing one or more tuners, one or more impedance tuners one or more aperture tuners, providing a radio frequency (RF) multiplexer and providing an RF diplexer, providing a connectivity hub module, providing one or more cables, providing one or more components. A connectivity hub module (CHM) sends commands for which RF bands to move and to what impedance tuners and/or aperture tuners state to which move. Each of the tuners may work on the same serial group IDs, or one or more serial group IDs.

### INTRODUCTION

The present disclosure relates to serial group ID address for automotive active/tunable antennas. Currently, no technologies exist for serial grouping ID addresses for automotive active/tunable antennas.

### SUMMARY

A system, or systems, for serial group ID address for automotive active/tunable antennas or a non-transitory computer-readable storage medium on which is recorded instructions. The systems may include at least one antenna and one or more tuners. The systems may further include one or more identical antennas and each antenna includes at least two tuners and/or each antenna includes three or more tuners. Generally, each of the tuners may work on one or more of the same serial group IDs – note that these may be different group IDs for different sets of tuners. Also, these group IDs may have a single User ID address.

The systems may further include providing one or more tuners, one or more impedance tuners one or more aperture tuners, providing a radio frequency (RF) multiplexer or providing an RF diplexer, providing a connectivity hub module, providing one or more cables, providing one or more components, including, without limitation: resistors, capacitors, inductors (coil, choke, reactor), diodes, LEDs, transistors, crystals, oscillators, and/or connectors, and may implement a serial group ID address for automotive tunable antennas.

This may include one or more connectivity hub modules (CHM) sending commands for which RF bands to move and to what impedance tuners and/or aperture tuners state to which to move the RF bands. Generally, each of the tuners may work on one or more of the same serial group IDs – note that these may be different group IDs for different sets of tuners. Also, these group IDs may have a single User ID address.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic view of a vehicle and cellular, or other, communication system which may be linked with one or more clouds.

FIG. 2 is a schematic diagram for group ID address for automotive active/tunable antennas.

FIG. 3 is a schematic diagram for group ID address for automotive active/tunable antennas.

FIG. 4 is a schematic diagram illustrating serial commands showing 2 sets of serial commands, one with several commands each for a unique User IDs address and one with a command with a group ID address (for all grouped users).

FIG. 5 is a schematic flow chart of a method or methods for serial group ID address for automotive active/tunable antennas.

### DETAILED DESCRIPTION

Referring to the drawings, like reference numbers refer to similar components, wherever possible. In general, group ID address for automotive active/tunable antennas, active smart antennas, or active antennas, are solutions that combine a passive antenna element, and active components such as RF (Radio Frequency) switches, diodes or transistors, and a driver or software to control the circuitry. These tuners are controlled through a serial BUS, in general each tuner has its own User ID address. Generally, each tuner may have its own User ID address. Tuners have a common ID address. This is called group ID address. This system would be unique, since all grouped tuners would be assigned the same ID address and would operate at the same state. This would be unique since the grouped ID tuners may be of different antennas and/or of different tuner types yet would operate in the same state.

These may be simply reference to as automotive tunable antennas. There are different types of active/tunable antennas, depending on which parameter is actively changing. Grouping the serial antennas ID addresses – such that grouping of ID addresses – provides different elements for the combining, or individualizing, the automotive active/tunable antennas.

An active antenna is an antenna that contains active electronic components such as transistors, as opposed to most antennas which only consist of passive components such as metal rods, capacitors and inductors. Active antenna designs allow antennas of limited size to have a wider frequency range (bandwidth) than passive antennas and are primarily used in situations where a larger passive antenna is either impractical, such as inside a portable radio or on a vehicle, or impossible, such as in a suburban residential area with restrictions on large outdoor antennas. Note that there may be tunable antennas, which are not necessarily, an active antenna.

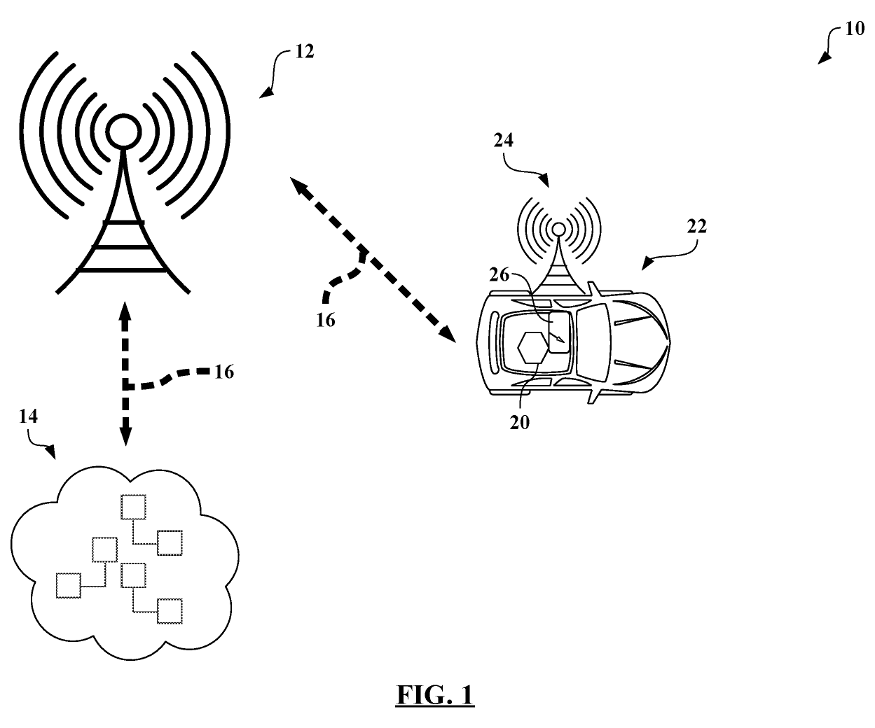

FIG. 1 schematically illustrates a connectivity network or connectivity system 10. The connectivity system 10 includes numerous components, only some of which are listed, and/or shown, herein. A remote or cellular communications system, or cellular network 12, which may be representative of many types of communications protocols, including, without limitation: cellular, satellite, Wi-Fi, Bluetooth, ultra-wideband (UWB) or other communications recognizable to those having ordinary skill in the art. UWB is a radio-based communication technology for short-range use and fast and stable transmission of data.

A centralized location 14 is shown highly schematically, but may be representative of many different structures, clouds, servers, or elements, as will be recognized by skilled artisans. The centralized location 14 represents systems that communicate with some, or all the other systems, and/or objects described herein. The centralized location 14 includes numerous controllers 20. Additionally, the centralized location 14 may be a back office (BO) of the manufacturer of the vehicles.

Several transfer protocols or transfers 16 are schematically illustrated. These transfers 16 may include, without limitation: cellular, Wi-Fi, wired networks, over-the-air (OTA), other transport protocols, including machine to machine (M2M), or other telematics equipment, or other systems recognizable by those having ordinary skill in the art. M2M systems use point-to-point communications between machines, sensors, and hardware over cellular, Wi-Fi, or wired networks.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting the claims or the description.

The term vehicle is broadly applied to any moving platform. Vehicles into which the disclosure may be incorporated include, for example and without limitation: passenger or freight vehicles; autonomous driving vehicles; industrial, construction, and mining equipment; and various types of aircraft.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary systems of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

A generalized control system, computing system, or controller 20 is operatively in communication with relevant components of all systems, and recognizable by those having ordinary skill in the art. The controller 20 includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or other communication protocols.

Furthermore, controller 20 may include, or be in communication with, a plurality of sensors. The controller 20 is configured to execute or implement all control logic or instructions described herein and may be communicating with any sensors described herein or recognizable by skilled artisans.

Any of the systems described herein may be executed by one or more controllers 20. Note that this algorithm may run on, generally, less expensive controllers 20. A vehicle 22 is shown in FIG. 1, but there may be other vehicles 22 that are not shown.

Note that a generalized antenna 24, or antennas 24, is shown generally attached the vehicle 22, and is shown highly schematically, like cellular network 12, centralized location 14, and transfer protocols 16 in FIG. 1. Note that there may be additional antennas 24, as will be recognized by those having ordinary skill in the art. Additionally, one or more tuners 26 may be used – the tuners 26 are shown highly schematically in FIG. 1 – and may be impedance tuners or aperture tuners, as described below.

The antennas 24 may have impedance tuners 28 and/or aperture tuners 30. Impedance tuners 28, may include, without limitation: antennas 24 bandwidth so that uniform insertion loss and return loss can be achieved at multiple frequencies for both transmit and receive directions; or due to broadening of bandwidth, undesired frequencies are passed; to stop, RF filtering is employed. Impedance tuners 28, may further include, without limitation: impedance tuning switches and antennas 24 form equivalent RLC, which may be an electrical circuit in which there is a resistor (R), an inductor (L), and a capacitor (C); and/or impedance tuners 28 help to boost power transfer between antennas 24 and RFFE (Radio Frequency Front End); and/or may require external passive components for bypassing; or may require filtering. Note that the impedance tuners 28 may also include RF matching networks.

Aperture tuners 30, may include, without limitation, one or more switches that must have low loss to avoid degradation of antenna radiating efficiency; or the switches may be shunting type or series type – or others recognizable to those having ordinary skill in the art – shunt type is widely used due to less ohmic loss than series type, hence high radiation efficiency can be achieved. Aperture tuners 30, may further include, without limitation: these systems allow the 5G system with antennas 24 to switch between frequencies by two ways: individual resonance can be tuned either capacitively or inductively, and/or aperture switch plus antennas 24 acts like the RLC circuit like aperture tuning above. These circuits may modify the natural frequencies of the antennas 24. The aperture tuners 30 may also include RF matching networks.

Using aperture tuners 30, electrical length of antennas 24 ground leg is adjusted to shift resonance of operating band. This may require enough electronic circuitry for external bypassing but, generally, does not require filtering. Aperture tuners 30 may help to boost isotropic sensitivity & radiated power, which may be achieved by optimization of efficiencies for transmit/receive frequencies.

Some multiplexers 32 (RF) combine multiple filters to a common port to create a multi-channel module. The multiplexer does the same with three or more lines instead of two, in electronics, a multiplexer, also known as a data selector, is a device that selects between several analog or digital input signals and forwards the selected input to a single output line. The selection is directed by a separate set of digital inputs known as select lines and multiple inputs and just one output to receive signals coming from multiple acquisition networks. Its block diagram consists of two parts: a distribution system, called a manifold, and a group of filters, which can be customized to meet lowpass, highpass, bandpass, or band stop requirements.

Some diplexers 34 are a passive (RF) filter component with three ports, which enables the sharing of a common antenna between two distinct frequency bands. Diplexers 34 combine two lines, each with different frequencies, into one single line. Two ports – e.g., L and H – are multiplexed onto a third port – e.g., S. The signals on ports L and H occupy disjoint frequency bands. Consequently, the signals on L and H can coexist on port S without interfering with each other. This technology allows transmitters operating on different frequencies to use the same antennas 24 and each band may both transmit and/or receive. These may be any type of antennas 24, including, without limitation, tunable and/or active.

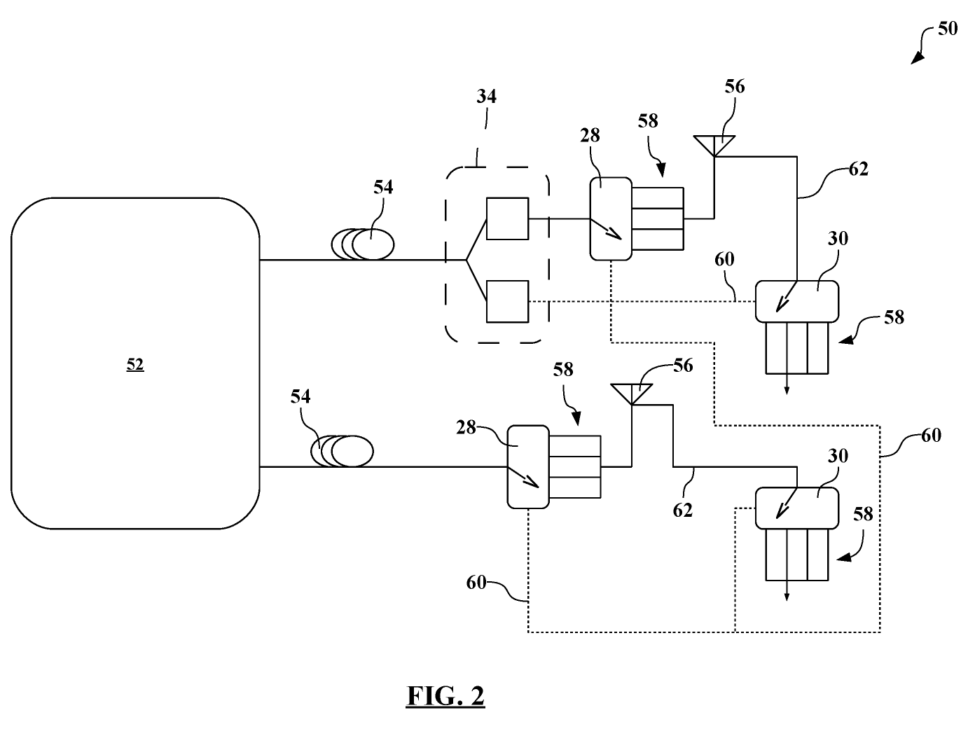

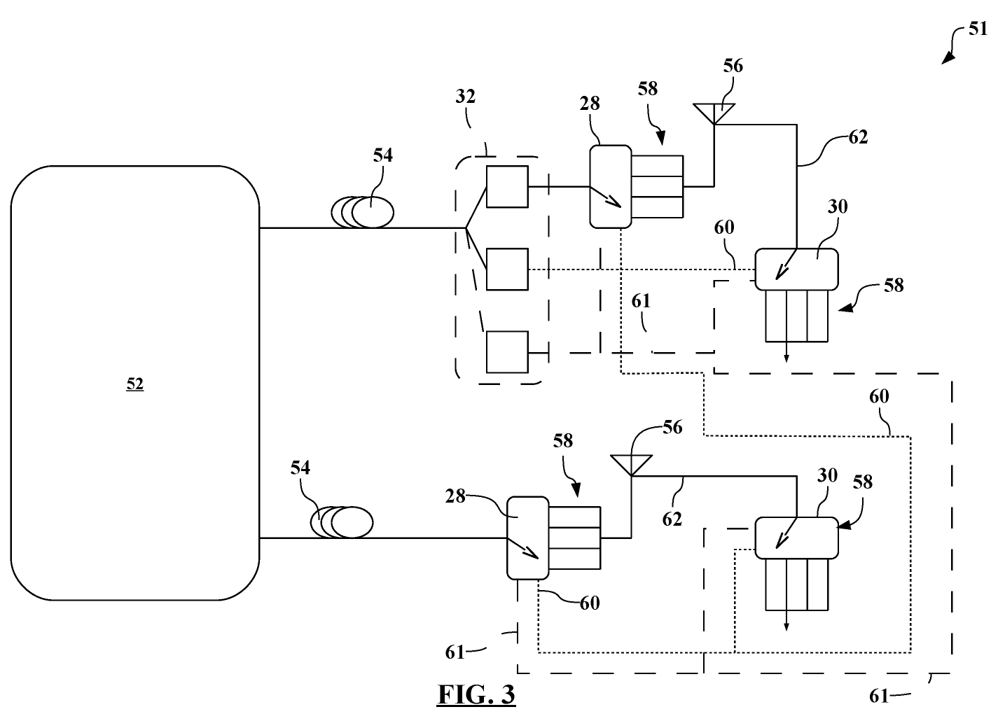

FIG. 2 is a schematic diagram of a set up for a serial group ID address for automotive active/tunable antennas 50, with one or more diplexers 34. FIG. 3 is a schematic diagram for serial group ID address for automotive active/tunable antennas 51, with one or more multiplexers 32. The FIGS. 2-3 will be described generally in the same descriptions. Note that the tuners 28/30 may be retuned in serial fashion – one after the next, where each one has its own User address – which may be the normal mode of operation.

This includes, at least, a connectivity hub module 52 (or CHM 52) and first and second cables 54, which may be RF cables and may be in any order. Note that the CHM 52, or the controllers 20, may be controlling the systems. One or more multiplexers 32 or diplexers 34, note that these may be used interchangeably and/or may be swapped for one another. FIG. 2 includes at least 2 of the diplexers 34 and FIG. 3 includes at least 3 of the multiplexers 32. There are at least two antennas 56, in addition to least two impedance tuners 28 and at least two aperture tuners 30 – note that each antenna 56 may have one impedance tuner 28 and/or one aperture tuner 30.

Generally, to support group ID address, all antennas 24 may need to be identical and/or have the same impedance tuners 28 and aperture tuners 30 and modes of operation. In some cases, the antennas 24 may not be identical and may have, have different impedance tuners 28, with different matching networks connected to the impedance tuners 28 and different aperture tuners 30. However, the impedance tuners 28 and aperture tuners 30 would have to work in the same state as first antenna 24. The significance is that the impedance tuners 28 and aperture tuners 30 are in the same states, and the antennas 24 may need to be designed appropriately.

Note that alterative antennas may not operate in the same state, which may cause issues for the alternative antennas. This eliminates the ability to use the same tuners in the same state thus causes issues.

Numerous components 58 may be located after the impedance tuners 28 and the aperture tuners 30. These may be any components recognizable to those having ordinary skill in the art, including, without limitation: resistors, capacitors, inductors (coil, choke, reactor), diodes, LEDs, transistors, crystals, oscillators, and/or connectors. Note that the RF line may be without components or an open RF line with no components.

The same impedance tuners 28 and aperture tuners 30 modes of operation. This means that both tuners 28/30 are in the same mode. This may be accomplished with impedance tuners 28 and aperture tuners 30 in, for example and without limitation, for a four-state tuner: 00, 01, 10, or 11. Note that those having ordinary skill in the art will recognize alternative configurations, including other modes, for impedance tuners 28 and aperture tuners 30.

Other tuners may have alternative states/configurations. The short, dashed lines in FIGS. 2-3 may be, without limitation, serial bus lines 60 – which may include power for the tuners 28/30 – and the long, dashed lines may be, without limitation, control lines 61, and the solid lines in FIG. 2 may be, without limitation, RF lines 62.

This may occur via the same impedance tuners 28 and aperture tuners 30 and may include differing serial group IDs for different sets of tuners 28/30. However, note that different sets of tuners 28/30 will operate on the same modes: 00, 01, 10, or 11 – or others. It is important to note that the tuners 28/30 will work on the same modes, even if connected to different antennas 56.

This ensures that the tuners 28/30 are working on the same modes – which means that all tuners 28/30, or groups of tuners 28/30, which may be separated into different groups, are working on the same modes. Note that all tuners 28/30 will operate on the same modes, such that all tuners 28/30 share the same state of operation. Again, note that different sets of tuners 28/30 may operate on different sets of modes, but they will be the same each group of tuners 28/30 on the same modes.

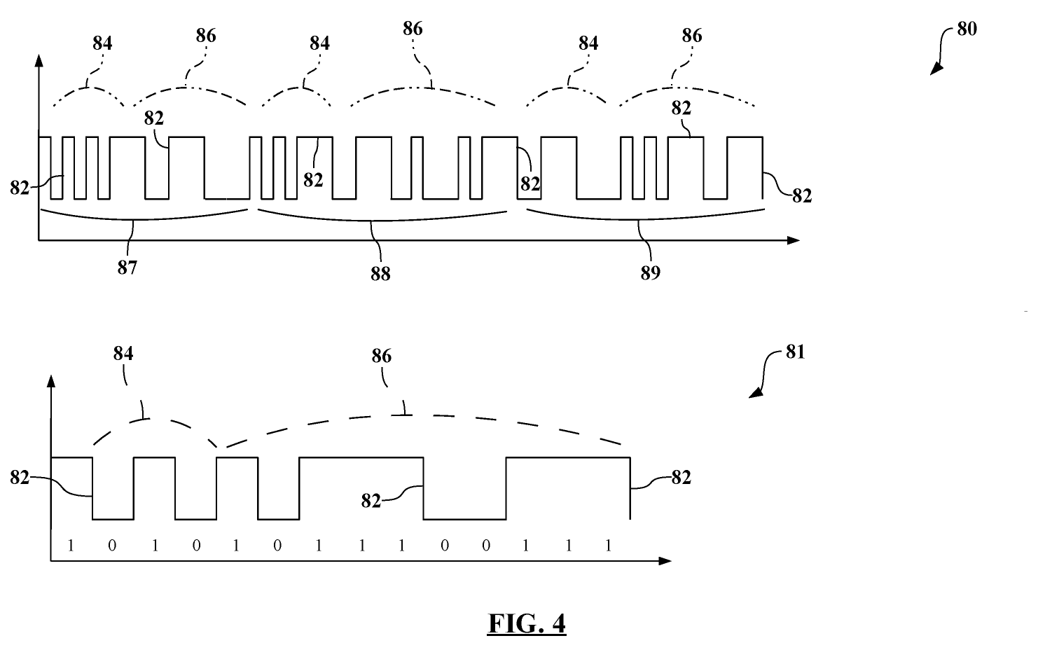

FIG. 4 is a schematic diagram illustrating serial commands. There is shown, generally, a diagram 80, which is the one with several commands which each have unique User ID addresses (per tuner). There are several different User IDs in the diagram, including, without limitation: User A command 87, User B command 88, and User C command 89 etc., each User ID refers to different tuners 28/30 (i.e., different user) each User command refers to different tuners 28/30 (i.e., different User ID Address, correspondingly: tuner A, tuner B & tuner C etc.)

In diagram 81, the tuners (i.e. users) may all receive the same group ID address block 84 and receive the same data command block 86, which is different from the diagram 80, such that the ID address block 84 is unique per tuner (i.e. user) and therefor the data command block 86 may defer from tuner to tuner (i.e. user to user). However, diagram 81 has reduced to a group ID. The diagram 81 has this reduced to a single group ID address for all grouped tuners. The first block is ID address block 84 and the second block is a data command block 86.

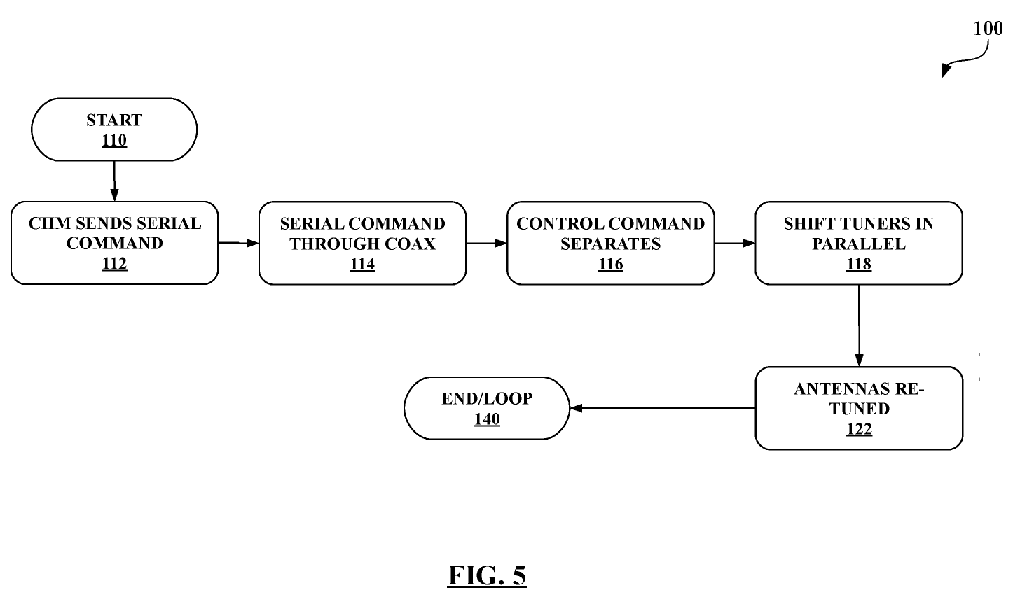

FIG. 5 is a schematic flow chart diagram of a method 100, or methods, for serial group ID address for automotive active/tunable antennas in one or more vehicles 22. One or more of the systems described herein may be executed by the controller 20, possibly as instructions recorded in a non-transitory computer-readable storage medium, or other structures or equipment recognizable to skilled artisans. All steps described herein may be optional, in addition to those explicitly stated as such, and all steps described may be reordered or removed. Any of the systems described herein may store the data in the centralized location 14 via the connectivity system 10 or other transfer protocols 16.

Step 110: START. At step 110, method 100 initializes or starts. Method 100 may begin operation when called upon by one or more controllers 20, or the CHM 52, may be constantly running, or may be looping iteratively.

Step 112: CHM SENDS SERIAL COMMAND. At step 112, method 100 sends the CHM 52 the serial group ID address for automotive active/tunable antennas 24. This may include one or more single group ID commands.

Step 114: SERIAL COMMAND THROUGH COAX. At step 114, method 100 send the control command is combined on, generally, RF lines 62 or through the first and second cables 54, which may be coaxial cables. This may also include one or more DC inputs.

Step 116: CONTROL COMMAND SEPARATES. At step 116, method 100 separates via one or more multiplexers 32 and one or more diplexers 34. This may occur via the first and second cables 54 (RF cables).

Step 118: SHIFT TUNERS IN PARALLEL. At step 118, method 100 shifts the tuners to the same settings. This, generally, switches the impedance tuners 28 and the aperture tuners 30 to the same state. As described above, this may include, without limitation: 00, 01, 10, or 11. Note that there may be a total of three or more tuners 28/30 or four tuners 28/30. Note that there may be split into two groups the impedance tuners 28 and the aperture tuners 30 each with its own serial group IDs, such that the different groups may function separately.

This shifts the tuners 28/30 in a parallel group ID address – such that the tuners 28/30 all shift, generally, at the same time. Also note that there may be setups that do not include aperture tuners 30. Further, note that there may be between 2 to 12 tuners 28/30 in the systems described herein.

Step 122: ANTENNAS RE-TUNED. At step 122, method 100 re-tunes the antennas 24. This may include switching both the functions separately via two separate serial group IDs. Note that this may be done by steps recognizable to those having ordinary skill in the art.

Step 140: END/LOOP. At step 140, the method 100 ends or loops. Ending/looping may include proceeding back to start step 110 or waiting until called upon to run again, such as by one of the CHM 52, or the controllers 20 or another portion of the connectivity system 10.

The detailed description and the drawings or figures are supportive and descriptive of the subject matter herein. While some of the best modes and other embodiments have been described in detail, various alternative designs, embodiments, and configurations exist.

“A”, “an”, “the”, “at least one”, and “one or more” are used interchangeably to indicate that at least one of the items is present. A plurality of such items may be present unless the context clearly indicates otherwise.

Furthermore, any examples shown in the drawings, or the characteristics of various examples mentioned in the present description, are not necessarily to be understood as examples independent of each other. Rather, it is possible that each of the characteristics described in one of the examples of an embodiment can be combined with one or a plurality of other desired characteristics from other examples, resulting in other examples not described in words or by reference to the drawings. Accordingly, such other examples fall within the framework of the scope of the appended claims.

1. A system, or systems, of using serial group ID address for automotive tunable antennas, comprising:
at least one antenna; and
one or more tuners, wherein each of the grouped tuners configure on the same serial group ID address.

2. A system, or systems, of using serial group ID address for automotive tunable antennas of claim 1, further comprising:
one or more identical antennas.

3. A system, or systems, of using serial group ID address for automotive tunable antennas of claim 2, wherein each antenna includes at least two tuners.

4. A system, or systems, of using serial group ID address for automotive tunable antennas of claim 2, wherein each antenna includes three or more tuners.

5. A system, or systems, of using serial group ID address for automotive tunable antennas of claim 2, further comprising:
one or more impedance tuners.

6. A system, or systems, of using serial group ID address for automotive tunable antennas of claim 5, further comprising:
one or more aperture tuners.

7. A system, or systems, of using serial group ID address for automotive tunable antennas of claim 6, further comprising:
a radio frequency (RF) multiplexer; or
a radio frequency (RF) diplexer.

8. A system, or systems, of using serial group ID address for automotive tunable antennas of claim 3, further comprising:
one or more impedance tuners; and
one or more aperture tuners.

9. A system, or systems, of using serial group ID address for automotive tunable antennas of claim 8, further comprising:
a radio frequency (RF) multiplexer; or
a radio frequency (RF) diplexer.

10. A system, or systems, of using serial group ID address for automotive tunable antennas of claim 9, further comprising:
a connectivity hub module (CHM), wherein the connectivity hub module generally controls the systems, wherein each of the tuners works on one or more of the same serial group IDs.

11. A system, or systems, of using serial group ID address for automotive tunable antennas of claim 10, further comprising:
one or more cables.

12. A system, or systems, of using serial group ID address for automotive tunable antennas of claim 1, further comprising:
a connectivity hub module (CHM), wherein the connectivity hub module generally controls the systems.

13. A system, or systems, of using serial group ID address for automotive tunable antennas of claim 12, further comprising:
one or more cables.

14. A method for using serial group ID address for automotive tunable antennas, the method comprising:
providing at least one antenna;
providing one or more tuners, including:
one or more impedance tuners; or
one or more aperture tuners;
providing a radio frequency (RF) multiplexer;
providing a radio frequency (RF) diplexer;
providing a connectivity hub module;
providing one or more cables;
providing one or more components, including, without limitation: resistors, capacitors, inductors, diodes, LEDs, transistors, crystals, oscillators, relays, switches, and/or connectors;
providing instructions for a serial group ID address for automotive tunable antennas; and
providing a connectivity hub module (CHM) which sends commands for which RF bands to move and to what impedance tuners and/or aperture tuners state to which to move, wherein each of the grouped tuners configured on the same serial group ID address.

15. A method for using serial group ID address for automotive tunable antennas of claim 14, further comprising:
at least two antennas, wherein each antenna includes at least three impedance tuners and/or aperture tuners.

16. A method for using serial group ID address for automotive tunable antennas of claim 15, wherein each of the tuners works on one or more of the same serial group IDs.

17. A system, or systems, of using serial group ID address for automotive tunable antennas, comprising:
one or more identical antennas; and
one or more tuners, wherein each of the grouped tuners configure on the same serial group ID address.

18. A system, or systems, of using serial group ID address for automotive tunable antennas of claim 17, wherein each antenna includes at least two tuners.

19. A system, or systems, of using serial group ID address for automotive tunable antennas of claim 18, further comprising:
one or more impedance tuners; or
one or more aperture tuners.

20. A system, or systems, of using serial group ID address for automotive tunable antennas of claim 19, wherein each of the tuners works on one or more of the same serial group IDs.
